(19) United States
(12) Patent Application Publication
(10) Pub. No.: US 2023/0044515 A1
(43) Pub. Date: Feb. 9, 2023

(54) DYNAMIC THIRD-PARTY INCENTIVIZATION OF SAVINGS BEHAVIOR

(71) Applicant: SUNNY DAY FUND SOLUTIONS INC., Falls Church, VA (US)

(72) Inventor: Siddhartha PAILLA, Falls Church, VA (US)

(21) Appl. No.: 17/879,194

(22) Filed: Aug. 2, 2022

Related U.S. Application Data
(60) Provisional application No. 63/228,748, filed on Aug. 3, 2021.

(51) Int. Cl. G06Q 30/02; G06Q 20/10

(52) U.S. Cl. CPC G06Q 30/0215; G06Q 20/102

(57) ABSTRACT

Disclosed herein are system, method, and computer program product embodiments for third-party sponsorship of incentives to beneficiaries via secure and continuous data retrieval across several sources of record. These sources of record may have multiple data layers across different servers and regulatory coverages. To incentivize beneficiaries to create mutually acceptable outcomes for both beneficiaries and sponsors, criteria with varying levels of detail may be established for the apportionment of incentives. To qualify beneficiaries, a multi-tier processor may retrieve securely from various internal and external data sources, confirm, qualify, quantify, and issue actions that result in the transfer of incentive from a sponsoring entity's account to an end beneficiary account. To enable such a processor to run across multiple sponsors and associated beneficiaries, the data architecture and retrieval process may provide incentive apportionment with full accuracy and scalability while segregating data storage and processing to achieve better security and privacy.

### CROSS-REFERENCE TO RELATED PATENT APPLICATIONS

The present application claims priority to U.S. Provisional Patent Application No. 63/228,748, filed on Aug. 3, 2021, which is incorporated herein by reference in its entirety.

### BACKGROUND

Conventional incentivization systems are inefficient and inflexible. For example, computational costs are wasted when an employee changes companies and is required to change their 401K account. Employees typically must open a new account, rollover previously saved funds, and then close the previous account—all of which may take weeks, require manual data transfers or calculations, and expose the privacy of the employee's balances. This is inefficient and results in wasteful computational costs. Further, conventional incentivization systems do not provide a flexible way to define incentive structures based on a beneficiary's behavior. Companies providing a benefit for employees to save funds do not have a streamlined system for defining algorithms or batch functions to execute savings transaction functions. Further, conventional systems cannot analyze private data as part of an incentive calculation due to a lack of privacy controls. This results in inflexible calculations that cannot account for private parameters.

### BRIEF SUMMARY

Disclosed herein are system, apparatus, device, method and/or computer program product embodiments, and/or combinations and sub-combinations thereof, for ledger management for entity incentivization.

Third-party sponsorship of incentives to beneficiaries may require secure and continuous data retrieval across several sources of record. These sources of record may have multiple data layers across different servers and regulatory coverages. To incentivize beneficiaries in such a manner as to create mutually acceptable outcomes for both beneficiaries and sponsors, criteria with varying levels of detail may be established for the apportionment of incentives. To qualify beneficiaries at the time of allocating such incentives, a multi-tier processor may retrieve securely data from various internal and external data sources. The multi-tier processor may confirm, qualify, quantify, and issue actions that result in the transfer of incentive from a sponsoring entity's account to an end beneficiary's account. To enable such a processor to run across multiple sponsors and associated beneficiaries, the data architecture and retrieval process may be architected to ensure incentive apportionment with full accuracy and scalability while segregating data storage and processing to improve security and privacy.

In some embodiments, an incentive processor may manage rules, algorithms, and/or criteria defined by a sponsor organization to manage savings transactions with beneficiaries. As further explained below, an example of a sponsor organization may be an employer while a beneficiary may be an employee. A sponsor may define or more saving incentive rules, which may be automatically executed by the incentive processor. For example, a rule may be that if an employee maintains a balance of at least $100 in a savings account, the employer will match 5% of the account balance quarterly. The incentive processor may monitor and/or manage account balance information across multiple employees to identify qualifying accounts. For example, the incentive processor may manage this data and/or retrieve the data via an API interface with a banking system. Upon identifying the qualifying accounts and/or account balances, the incentive processor may generate a benefit value corresponding to the amount to be paid by the employer to qualifying employees. In some embodiments, the benefit value may be a singular value indicating a total amount to be paid by the employer. The incentive processor may then conduct one or more transactions via one or more banking APIs to retrieve funds from the employer account and to distribute the funds to the individual employee accounts.

As part of this retrieval and disbursement process, the incentive processor may preserve privacy for employees. For example, the incentive processor may conceal bank account balances for the employees. Employers may be prevented from accessing this confidential information while still providing the desired benefits. Returning to the example of matching 5% of an account balance quarterly, employers may be notified of an overall amount to be paid and/or disbursed, but the identity of the qualifying employees may be concealed and/or masked. Similarly, the specific account balances may also be concealed and/or masked from the employer. The incentive processor may perform the monitoring and/or management of account information and determine a particular amount for the employer to distribute to provide the 5% match to qualifying employees. In this manner, employees may be incentivized to contribute and/or save earnings based on the criteria defined by employers while still maintaining privacy, confidentiality, and/or separation from employers. Employers may be informed of an amount for distribution but may not specifically identify the individual employees receiving the benefit.

By implementing the incentive processor, savings transactions may be automated and/or streamlined for sponsors, beneficiaries, and/or banking institutions. The incentive processor may provide one or more graphical user interfaces for sponsors to implement rules, algorithms, and/or criteria. For example, such graphical user interfaces may allow definitions based on percentages, timing, and/or other values to motivate savings behavior by beneficiaries. Similarly, the incentive processor may generate one or more graphical user interfaces for use by the beneficiaries to view balances and/or to track received benefits. In some embodiments, the graphical user interfaces may display the rules, algorithms, and/or criteria defined by the sponsors. This may inform beneficiaries of benefits that may be received if conditions are met. The graphical user interfaces may also provide messages and/or reminders to encourage savings behavior. In some embodiments, beneficiaries may set their savings contributions using the one or more graphical users interfaces to configure the incentive processor as well.

Based on the interactions with sponsors and/or beneficiaries, the incentive processor may automatically route contributions from beneficiaries and/or disbursements from the sponsors. In some embodiments, the incentive processor may issue commands via a banking institution API and/or via the use of batch functions. As previously explained, this automated routing may conceal and/or mask sensitive, personal, or confidential beneficiary data. In this manner, the incentive processor may provide a communication and/or transaction pathway that maintains beneficiary privacy. Additionally, the automated routing provided by the incentive processor may reduce computational resources that may be expended by sponsor systems to manage and/or update distributions. The incentive processor may provide a streamlined process that may communicate with the sponsor's payroll system to perform a simplified transaction to disburse payments to multiple beneficiaries. In some embodiments, a single payment or distribution may be requested from the sponsor's system thereby reducing the computational resources needed by the sponsor's system to distribute benefits.

### BRIEF DESCRIPTION OF THE DRAWINGS

The accompanying drawings are incorporated herein and form a part of the specification.

FIG. 1 depicts a block diagram of a ledger overview, according to some embodiments.

FIG. 2 depicts a block diagram of a sponsor overview, according to some embodiments.

FIG. 3 depicts a block diagram of a beneficiary overview, according to some embodiments.

FIG. 4 depicts a block diagram of an incentive processor overview, according to some embodiments.

FIG. 5 depicts a block diagram of an incentive processor at scale, according to some embodiments.

FIG. 6 depicts an example computer system useful for implementing various embodiments.

FIG. 7 depicts a flowchart illustrating a method for distributing an incentive amount from a first account to a second account, according to some embodiments.

FIG. 8 depicts a flowchart illustrating a method for distributing an aggregated incentive amount to one or more beneficiary accounts, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for managing one or more ledgers for entity incentivization. An incentive processor may analyze financial information and provide incentivizations for tracked entities based on customized rules. The incentive processor may conceal underlying private data used to calculate an incentive amount. The concealed underlying private data may be associated with the recipient of the incentive.

Four types of entities will be discussed in this disclosure: sponsors, beneficiaries, ledgers, and incentive processors.

A sponsor may provide incentive to beneficiaries based on certain conditions met. A sponsor may be someone like an employer or an organization. A sponsor may be an organization that manages incentives for beneficiaries or clients and/or manages incentive rates.

A beneficiary may receive an incentive based on their attributes and/or behavior. Behavior may include actions performed by the beneficiary that modify the balances of their respective account in ledger, or contextualize the use of the resources in said account for any self-ascribed purpose or goal. A beneficiary may be, for example, an employee. In some cases, when the sponsor is an organization or a third-party organization, the beneficiary may be an individual within the organizational ecosystem. For example, the beneficiary may be an organization's client.

A ledger may be a source of record and/or storage for units of value, from and into which incentives are drawn or deposited. For example, a ledger may track bank deposit account information or be a bank account. The ledger may be nested ledgers like custodial accounts. The ledger may be a source of record for a custodial account associated with one of the more entities or a deposit account or multiple different entities. The ledger may be a database table or a data store. Nested ledgers may encapsulate data stores across several servers.

An incentive processor may determine the value of incentives based on data connections. The incentive processor may analyze underlying private data related to a beneficiary to determine whether the beneficiary is qualified to receive an incentive or reward. The incentive processor may also calculate an incentive amount to distribute. This determination and calculation may be performed based on sponsor-defined criteria. The incentive processor may also provide portability for the beneficiary if the beneficiary becomes associated with multiple sponsors, either in series or in parallel. The functionality and operations of the incentive processor are further described below.

Various embodiments of these features will now be discussed with respect to the corresponding figures.

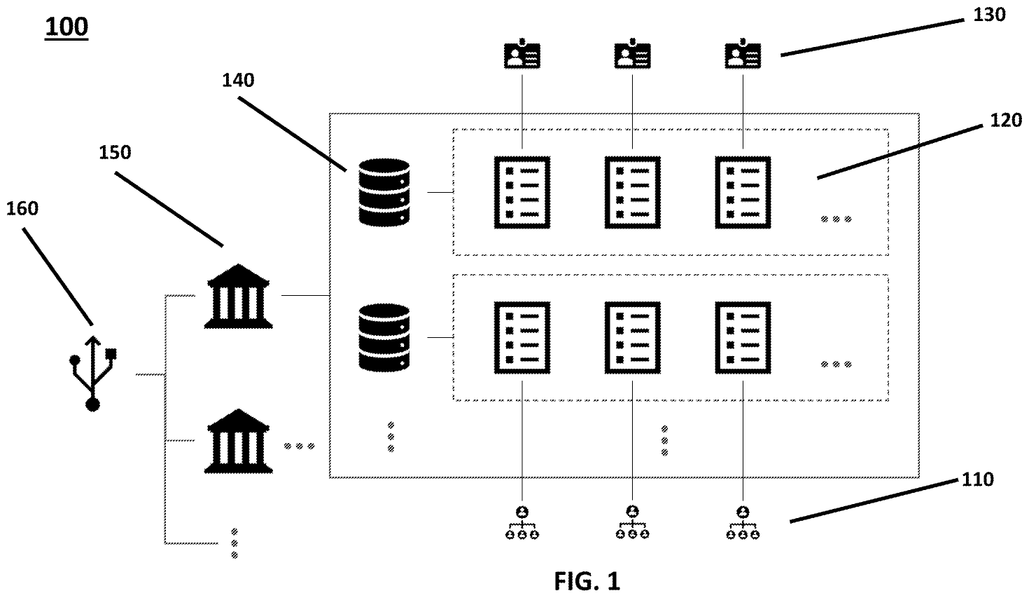

FIG. 1 depicts a block diagram of a ledger overview, according to some embodiments. FIG. 1 depicts a ledger environment 100. Ledger environment 100 may include sponsors 110, beneficiaries 130, and ledgers 150. Each sponsor 110 and/or beneficiary 130 may include a corresponding individual record 120. An individual record 120 may include personal identifiable information (PII) and/or current stored value. Individual records 120 may be managed by databases 140. Databases 140 may be associated with a data warehouse on a server and/or series of servers. The servers may be separately secured and/or firewalled. Ledgers 150 may connect to a network 160. Network 160 may be an interbank or interbank money movement network.

In some embodiments, ledgers 150 may include a financial institution or a third-party administrator that serves as a record keeper through a series of databases for individuals and businesses. Within each database 140 may be a dedicated ledger record. The dedicated ledger record may be an account. The account may be associated with sponsor and/or beneficiary entities. In some embodiments, multiple ledgers 150 may interact through a global allocation transmitter. This may be network 160. Network 160 may be a money movement network.

Ledger 150 may manage different data store elements. A ledger 150 may be a data lake. Ledger 150 may manage multiple different databases 140. Each database 140 may have an associated account with an individual. Databases 140 may also manage an account associated with a corporate entity or sponsor 110. Sponsor 110 may be organized in a hierarchical structure. Ledger 150 may manage a hierarchical organization of different accounts of record and/or different databases 140. As will be later described, an incentive processor may interface with accounts themselves and/or with ledgers 150. This may interface with a hierarchical database, which may be organized via account number and/or routing number. The hierarchy may organize routing numbers above account numbers.

Ledger 150 may connect to a money movement network 160. Ledger 150 may use money movement network 160 to distribute stores of value from within one account to another account. Network 160 may move money between banks and/or between different ledgers 150 of record. This may occur when multiple different ledgers 150 of record exist. Funds may be transmitted via network 160.

In some embodiments, each beneficiary 130 may have an account. Each sponsor 110 may have an account or ledger. The sponsors 110 may have multiple accounts as well. In some embodiments, sub-ledgers may be used where sponsors and beneficiaries are sharing the same main ledger. For example, a sponsor 110 and beneficiary 130 may both have accounts using Bank X. In this case, the sponsor 110 and beneficiary 130 may have sub-ledgers within the main ledger associated with Bank X. In some embodiments, sponsor 110 may have an account with Bank Y while beneficiary 130 may have an account with Bank Z. In this manner, the sponsor 110 and beneficiary 130 may have different ledgers associated with different banks. As will be further explained below, an incentive processor may read account and/or ledger information to determine an incentive to distribute to a beneficiary 130. The incentive processor may send a command to network 160 to cause the transfer of the incentive. Network 160 may be a money moving network.

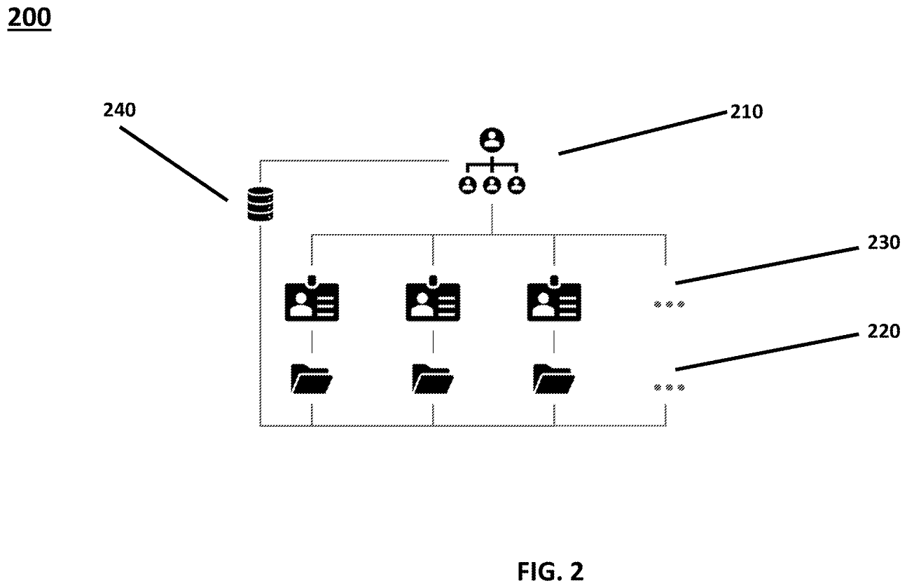

FIG. 2 depicts a block diagram of a sponsor overview, according to some embodiments. FIG. 2 depicts a sponsor environment 200. Sponsor environment 200 may include a sponsor 210, beneficiaries 230, beneficiary-level data 220, and/or database 240. The beneficiary-level data may be PII.

Each sponsor 210 may have one or more beneficiaries 230. There may be a formal and/or legal relationship between sponsors 210 and beneficiaries 230. Sponsors 210 may manage data records (beneficiary-level data 220) associated with each beneficiary 230. Beneficiary-level data 220 may be related to the nature of the relationship between sponsor 210 and beneficiary 230. Beneficiary-level data 220 may include beneficiary 230 classification data and/or a length of relationship. Beneficiary-level data 220 may also include other data related to the relationship between sponsor 210 and beneficiary 230.

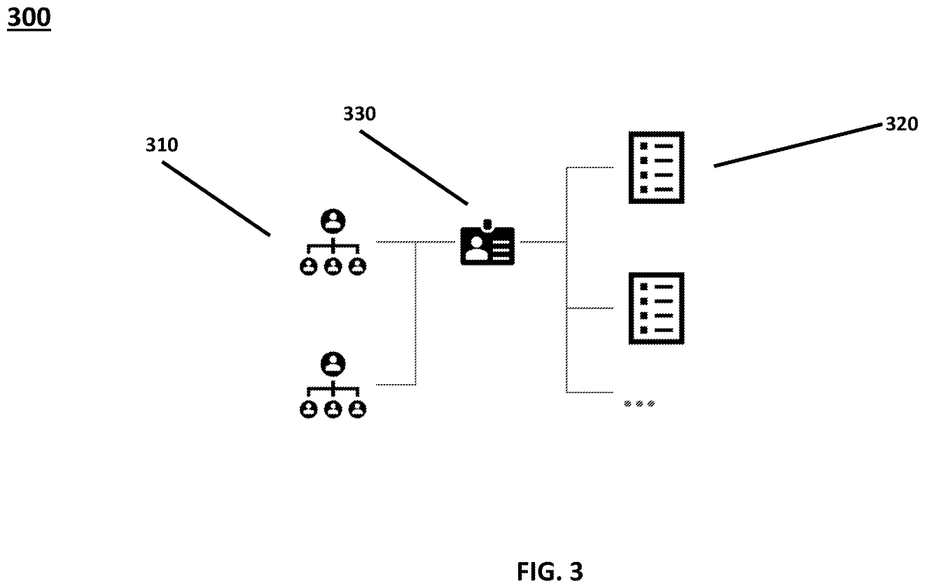

In some embodiments, sponsors 210 and beneficiaries 230 may have a hierarchical relationship. In some embodiments, there may be a many to many relationship with beneficiaries 230 having many relationships with different sponsors 210 and/or vice versa. For example, one beneficiary 230 may have been receiving an incentive from a single sponsor 210, but may then leave that sponsor's 210 scope and go to a different sponsor 210. That same beneficiary 230 may still have access to the same data records 220. As will be further explained below, an incentive processor may recognize this change and determine that a pending incentive will pick up where it has left off. This incentive will then be evaluated under the rules of the new sponsor 210. This may be referred to as portability and is further described with reference to FIG. 3.

In this case, the sponsor 210 may manage their own database 240. Underneath that database 240, sponsor 210 may manage different sources of value associated with their beneficiaries 230. The databases 240 may store beneficiary-level data 220. Beneficiary-level data 220 may identify the beneficiary 230, the type of relationship that exists between beneficiary 230 and sponsor 210, whether there is an employment relationship, an employer/employee relationship, a contractor relation, an organizational level of the beneficiary 230, how long the beneficiary 230 has been with the company, and/or other data. This information may be stored in a file that is underneath database 240.

In some embodiments, an incentive processor may conceal beneficiary 230 account information from sponsors 210. For example, a bank account balance may be concealed. This may preserve privacy and/or comply with banking rules or regulations. In some embodiments, sponsors 210 may be able to review aggregate information. This may include statistics about how much is being saved across their entire organization.

FIG. 3 depicts a block diagram of a beneficiary overview, according to some embodiments. FIG. 3 depicts a beneficiary environment 300. Beneficiary environment 300 may include sponsors 310, a beneficiary 330, and/or ledger records 320. The ledger records 320 may be similar to beneficiary-level data 220 as described with reference to FIG. 2. The ledger records 320 may be PII. Beneficiary 330 may have at least one ledger record. In some embodiments, beneficiary 330 may have multiple ledger records 320 at multiple institutions, as further explained below. In beneficiary environment 300, beneficiary 330 may have a relationship with one or more sponsors 310. These relationships may occur one after another or may be in parallel.

In some embodiments, beneficiary 330 may change from one sponsor 310 to another sponsor 320. The incentives and/or account information corresponding to the beneficiary 330 may be moved to the new sponsor 210. The changing of sponsors 310 for a beneficiary 330 may be referred to as portability. As will be further explained below, an incentive processor may provide this portability. This portability may be applicable to organizational sponsors 310 which may or may not be employers. In an example embodiments, Beneficiary A may work for Sponsor X. Beneficiary A may have been receiving incentives as a part of his employment at Sponsor X. Beneficiary A may leave Sponsor X and start working for Sponsor Y. Sponsor Y may also utilize an incentive processor used to manage incentives for beneficiaries 330. Beneficiary A may already have an existing account being managed by the incentive processor along with a bank account or ledger record 320. In this case, as will be further explained below, the incentive processor may shift the association with Sponsor X to Sponsor Y to continue managing incentives. To Beneficiary A, the account view may remain the same. In some embodiments, there is no change in balance from one account to another. Beneficiary A may access the same account.

Beneficiaries 330 may have multiple relationships with one or more sponsors 310. A beneficiary 330 may have one or more ledger records 320. This may occur when the beneficiary 330 opens a new ledger record 320 associated with a new bank account in addition to one that already exists. In some embodiments, this may arise when a beneficiary 330 works at two sponsors 310. For example, Beneficiary A may work at both Sponsor X and Sponsor Y simultaneously. The ledger record 320 associated with Sponsor X may be separate from the ledger record 320 associated with Sponsor Y. In this way, more than one ledger record 320 may be associated with Beneficiary A. Both accounts or ledger records 320 may still be portable. In some embodiments, the ledger records 320 may be linked. Having multiple ledger records 320 may be a consumer choice.

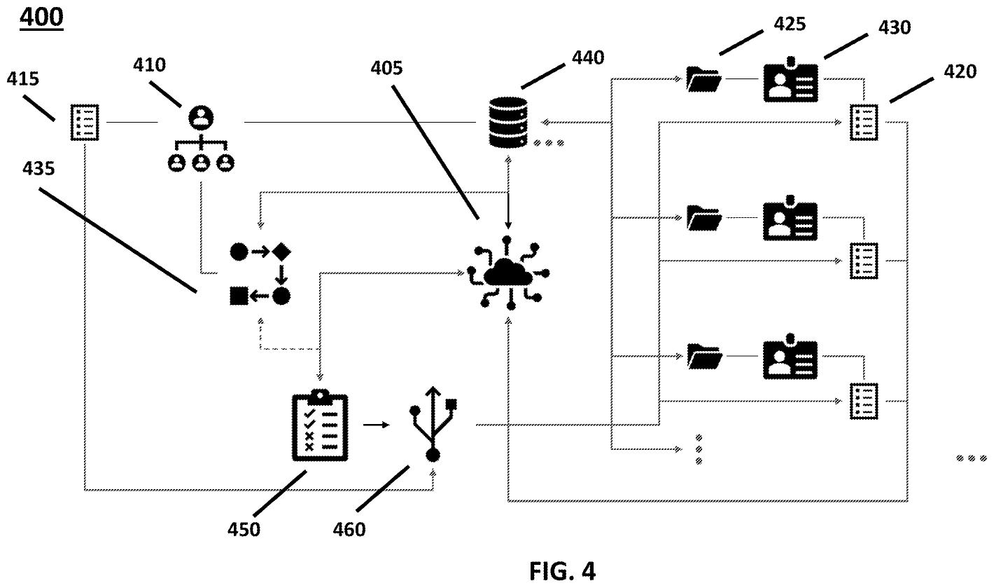

FIG. 4 depicts a block diagram of an incentive processor overview, according to some embodiments. FIG. 4 depicts an incentive processor environment 400. Incentive processor environment 400 may include an incentive processor 405, a sponsor 410, ledger records 415, 420, beneficiary-level data 425, beneficiaries 430, customizable incentive criteria 435, database 440, API mapping 450, and/or network 460. Sponsor 410, ledger records 415, 420, beneficiaries 330, database 440, and/or network 460 may be similar to those previously described with reference to FIG. 1, FIG. 2, and FIG. 3.

Customizable incentive criteria 435 may be set by sponsor 410 to determine the amount of incentive a beneficiary 430 will earn during an incentive cycle. These may be rules and/or conditions defined by sponsor 410 to determine incentivizations. For example, customizable incentive criteria 435 may be associated with beneficiary classification or length of relationship between beneficiary 430 and sponsor 410. Customizable incentive criteria 435 may be based on behavior of the beneficiary 430, such as ongoing contributions, balances, and withdrawals. As will be further explained below, customizable incentive criteria 435 may be derived by incentive processor's 405 access to beneficiary's 430 ledger records 420. Application of customizable incentive criteria 435 by incentive processor 405 may result in a frequency of rewards, incentive rates, incentive limits, lottery rates and rules, and/or take-away rules. Take-away rules may define a set amount or value from which a beneficiary 430 will lose an incentive amount due to a lack of qualifying participating behavior.

API mapping 450 may define an internal API mapping qualification and/or quantity of reward based on ledger records 415, 420 and/or beneficiary-level data 425. This may apply customizable incentive criteria 435 retrieved by incentive processor 405.

Incentive processor 405 may manage incentives provided by sponsor 410 to beneficiary 430 based on customizable incentive criteria 435. Incentive processor 405 may be connected to a database 440. Database 440 may be synced to sponsor 410. Sponsor 410 may be a corporate entity. Database 440 may also be synced to beneficiary-level data 425 and/or files associated with each of the individual beneficiaries 430.

Sponsor 410 may manage this data using database 440. Database 440 may also include metadata associated with the sponsor 410 and/or the beneficiary 430. Database 440 may be a storage facility storing period data at which the different incentives are happening. This data may correspond to sponsor 410. Sponsor 410 may define when the incentives occur and/or incentive periods. Incentive processor 405 may be synced with database 440 to know when to process the incentives. Incentive processor 405 may apply customizable incentive criteria 435 to the data to manage incentives.

Customizable incentive criteria 435 may include a set of rules. For example, these set of rules may be a program, programming, and/or software defined by sponsor 410. The set of rules may define incentive models and/or incentive structures. The rules may be a customizable set of incentive rules. Sponsor 410 may identify a resulting incentive based on employee activity. In an example embodiment, the incentive may correspond to a savings account and/or a 401K account corresponding to a beneficiary 430. For example, the incentive may be a 5% match, except the first 3% is dollar for dollar and then the next one comes as $0.50 on the dollar, up to 5%. Customizable incentive criteria 435 may include customizable rules like these. In some embodiments, the account corresponding to beneficiary 430 may be a savings account. Sponsor 410 may offer a reward or incentive amount such as a 5% match based on a balance maintained in the savings account. In some embodiments, this may be a subsidized interest rate. The match provided by sponsor 410 may be in addition to a disbursement of interest provided by a financial institution. In some embodiments, disbursement may be a flat amount.

Other rules may be based on tenure or years of service. For example, if an employee has worked for an employer for a year, the employee's rate might increase from 5% to 5.5%. This may reduce retraining turnover-related costs. In some embodiments, the rules may also be defined based on tiers. The tiers may correspond to seniority or rank within the company or within a team in the company. The tiers may or may not be tied to how long an employee has been working at a company. For example, a customer service call center person may not receive the same rate as a manager. Incentive processor 405 may calculate an average daily balance corresponding to the rates to determine an amount to distribute.

As previously explained, the rules may also correspond to beneficiary 430 behavior. This behavior may include ongoing contributions, balances, and withdrawals derived by incentive processor 405. In some embodiments, incentive processor 405 may have direct access to the beneficiary's 430 ledger. Incentive processor 405, however, may not reveal account information to the employer. For example, incentive processor 405 may conceal a balance amount or daily transactions while still using this information to manage incentives. Using this information, incentive processor 405 may determine criteria results and/or how frequently to distribute incentive rewards. This determination may be based on incentive rates, incentive limits, lottery rates and rules, and/or takeaway rules as previously described. A takeaway may be a set of rules that may be contrasted from building up an incentive. For example, a beneficiary 430 may start with $500 as an incentive, but the incentive may be reduced depending on the rules. This may be customizable.

Sponsors 410 may modify these rules to analyze different data stores with different privacy layers in place. Incentive processor 405 may preserve privacy while automating transactions based on customizable incentive criteria 435. For example, while incentive processor 405 may determine an incentive amount and inform sponsor 410 of the amount, the underlying private data corresponding to beneficiary 430 may remain confidential and/or kept private.

Incentive processor 405 may analyze the rules and compare the rules to real life data corresponding to the beneficiary 430 accounts. Based on the activity of the accounts and/or the details of the associated beneficiary 430, incentive processor 405 may determine whether the beneficiary 430 has met the associated set of rules. Incentive processor 405 may also analyze other information in database 440 to determine whether the rules are satisfied.

Incentive processor 405 may determine that the rules are satisfied and/or determine an incentive to provide. For example, this may be a calculation of an incentive amount to be distributed to beneficiary 430. Incentive processor 405 may then use API mapping 450 to transmit a command to network 460 distribute the incentive. For example, incentive processor 405 may send a push command to a money transfer network 460 to take a calculated amount associated with the sponsor's 410 own account within their ledger to push that amount to a beneficiary 430 account. This may be a push between different ledgers associated with each one of the beneficiaries 430.

In some embodiments, incentive processor 405 may generate a graphical user interface dashboard to depict an estimated and/or upcoming award or incentive. In some embodiments, incentive processor 405 may use a formula to calculate reward based on a rolling number based on an average daily balance. Incentive processor 405 may estimate a reward for a beneficiary 430 based on past behavior. For example, incentive processor 405 may estimate and/or forecast an incentive for an upcoming cycle and/or future cycle based on previous reward or incentive cycles. In some embodiments, the graphical user interface dashboard may indicate and/or display a condition for obtaining an incentive or award, a process for calculating the incentive or award, and/or an account balance for an account corresponding to a beneficiary 430.

In some embodiments, the graphical user interface dashboard may allow the beneficiary 430 to define one or more goals. These goals may include savings goals and/or may partition an account balance into different categories. For example, savings goals may be general savings goals, an emergency fund, a goal for a particular purchase, and/or other goals that may be defined by beneficiary 430 when accessing the graphical user interface dashboard. Incentive processor 405 may store such data in a database when maintaining account data corresponding to beneficiary 430. In some embodiments, a savings goal may allow users investment opportunities. For example, when designating a particular portion of savings to invest in stocks, bonds, and/or mutual funds, incentive processor 405 may interface with financial institutions to invest such funds. In some embodiments, incentive processor 405 may offer risk-free interest such that interest may be provide via a banking partner and/or via sponsor 410 when providing awards.

Incentive processor 405 may also track a running calculation so that the closer a reward date is (e.g., end of a calendar quarter), the more accurate the calculation will be. The dashboard may depict this estimate reward and/or incentive amount. The dashboard may also include a counter indicating the remaining days for an incentive. For example, the dashboard may include a counter saying “23 days to go” to inform a beneficiary 430. The dashboard may depict this amount with the estimated incentive amount. In some embodiments, an incentive criteria 435 may also include time-based rewards and/or booster rewards. For example, sponsor 410 may designate a reward indicating that if a beneficiary 430 maintains an minimum account balance for six months, an additional booster award of 10% may be provided to the beneficiary 430. In this case, the dashboard may also display this information as a reminder to the beneficiary 430.

In terms of operation, incentive processor 405 may analyze data from different data sources. For example, incentive processor 405 may read data from different source and store in data in its own internal servers for a temporary basis. Incentive processor 405 may then retrieve the customized incentive criteria 435, determine whether the beneficiary qualifies for an incentive, and if so, calculate the incentive. After quantifying the incentive, incentive processor 405 may request from sponsor 410 that the incentive calculation is approved. In this manner, sponsor 410 may provide approval for the incentive or reward calculation. In some embodiments, incentive processor 405 may be configured to proceed with incentive distribution without requiring each calculation to be approved by sponsor 410. This may help in cases of scale where there are many beneficiaries and/or transactions. Incentive processor 405 may be pre-approved to proceed.

Once incentive processor 405 has been approved to proceed, incentive processor 405 may initiate an intra-bank transfer or an inter-bank transfer. This may occur via network 460. If incentive processor 405 initiates an inter-bank transfer, or an inter-ledger transfer, network 460 may be a money mover receiving the command. The money mover network 460 may then perform the transfer. Incentive processor 405 may then read the data from the different accounts and/or ledgers corresponding to the sponsor 410 and beneficiary 430 to confirm that the incentive or reward was correctly distributed.

In some embodiments, incentive processor 405 may be configured to distribute incentives and/or rewards on a set period basis. This may be according a sponsor's 410 customized incentive criteria 435. During this period, incentive processor 405 may confirm data records across both sponsor 410 and beneficiary 430, including status of respective ledger records 415, 420 and the continued relationship between sponsor 410 and beneficiary 430. Incentive processor 405 may also retrieve beneficiaries' 430 detail stored internal to incentive processor's 405 assigned servers as well as servers external to incentive processor 405. These may be servers and/or databases associated with ledger records 415, 420. Incentive processor 405 may retrieve customized incentive criteria 435 associated with the sponsor 410 and/or map and/or qualify eligibility of beneficiary 430 to receive incentive based internal API mapping 450. Incentive processor 405 may quantify incentives associated with each beneficiary 430 and/or across all eligible beneficiaries 430. Pending confirmation from sponsor 410, incentive processor 405 may issue a request to transfer the quantified units over a money movement network 460 from sponsor's 410 ledger 415 to beneficiaries 430 ledgers 420. When the transfer is intra-bank, the transfer may be performed automatically by network 460. When the transfer is inter-bank, the transfer may account for outside regulatory confirmations. Ledgers 415, 420 may be updated to reflect new balances. Incentive processor 405 may read ledgers 415, 420 to confirm the new balances.

In some embodiments, beneficiaries 430 may request a withdrawal of funding from an account maintained by incentive processor 405. In this case, incentive processor 405 may issue a deposit to another account and/or transmit a command via an API to a banking institution to move funds and/or issue a check. Similarly, incentive processor 405 may facilitate community borrowing among beneficiaries 430. In this case, beneficiaries 430 may lend and/or borrow funds from other beneficiaries 430. When lending, a beneficiary 430 may have identified funding from an account to be used for lending purposes. In this case, incentive processor 405 may facilitate peer-to-peer loans and/or repayment. This may be operational in a cloud computing environment. Further, incentive processor 405 may conceal this community loaning from a sponsor 410 such privacy for borrowers and/or lenders is preserved. Similarly, in some embodiments, incentive processor 405 may conceal the identity of beneficiaries 430 from each other such that privacy among beneficiaries 430 is preserved as well.

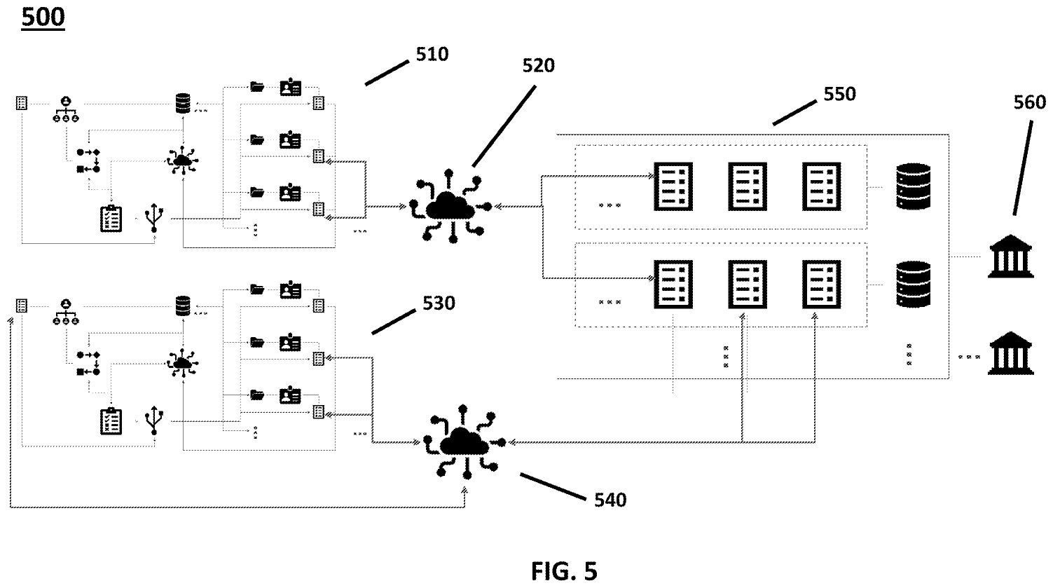

FIG. 5 depicts a block diagram of an incentive processor at scale, according to some embodiments. At scale environment 500 may include organizations 510, 530; incentive processors 520, 540; databases 550; and/or ledgers 560. These components may be similar to those described with reference to FIGS. 1-4. Scale environment 500 may demonstrate the use of incentive processors 520, 540 to provide scalability for managing incentives and/or rewards across multiple organizations 510, 530 and/or for different beneficiaries. Incentive processors 520, 540 may interface organizations 510, 530 with databases 550. Databases 550 may include the ledger records for sponsors and/or beneficiaries across multiple organizations 510, 530. Ledgers 560 may manage databases 550.

In this manner, incentive processors 520, 540 may provide portability even at scale and across multiple organizations 510, 530. The incentive processing may occur across multiple different accounts and/or across multiple different ledgers 560. As previously explained, incentive processors 520, 540 may track multiple sponsor/beneficiary relationships. In this case, different sponsors may define different sets of rules for each beneficiary. Incentive processors 520, 540 may then manage and apply these rules for corresponding beneficiaries. This may occur even when a beneficiary is associated with multiple organizations 510, 530. As explained with reference to FIG. 4, incentive processors 520, 540 may interface with databases 550, ledgers 560, and/or money mover networks to distribute incentives and/or rewards.

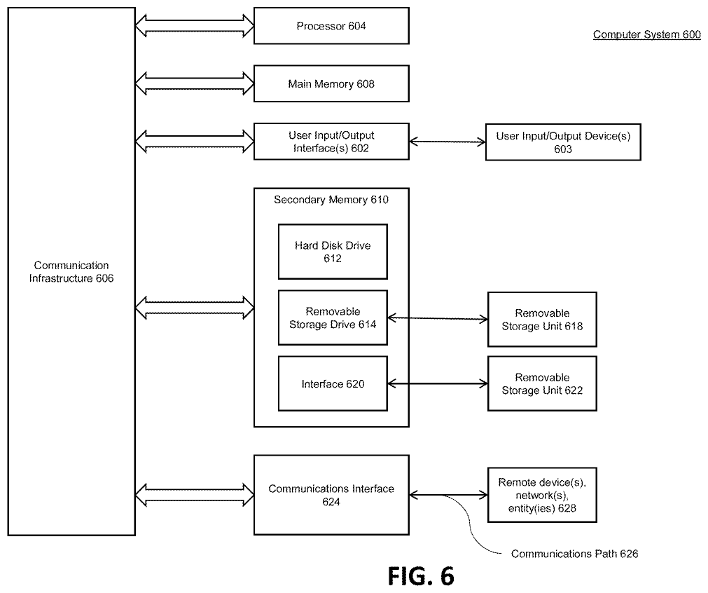

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/ any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

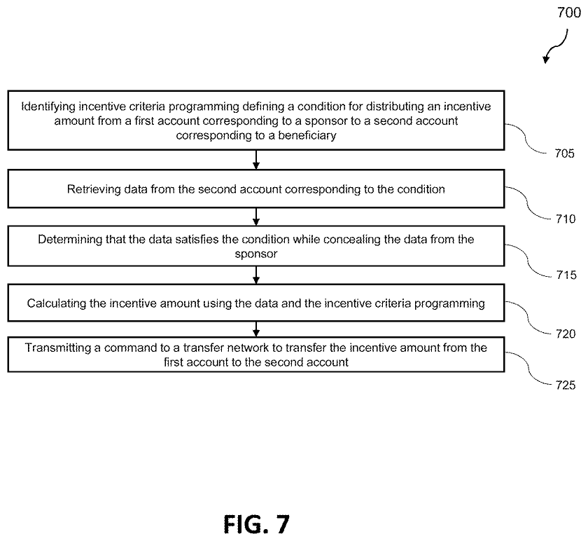

FIG. 7 depicts a flowchart illustrating a method 700 for distributing an incentive amount from a first account to a second account, according to some embodiments. Method 700 shall be described with reference to FIG. 4; however, method 700 is not limited to that example embodiment.

In an embodiment, incentive processor 405 may utilize method 700 to distribute an incentive amount from a first account to a second account. The first account may correspond to sponsor 410. The second account may correspond to beneficiary 430. The foregoing description will describe an embodiment of the execution of method 700 with respect to incentive processor 405. While method 700 is described with reference to incentive processor 405, method 700 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof

It is to be appreciated that not all steps may be needed to perform the disclosure provided herein. Further, some of the steps may be performed simultaneously, or in a different order than shown in FIG. 7, as will be understood by a person of ordinary skill in the art.

At 705, incentive processor 405 may identify incentive criteria programming defining a condition for distributing an incentive amount from a first account corresponding to sponsor 410 to a second account corresponding to a beneficiary 430. The incentive criteria programming may be incentive criteria 435 as described with reference to FIG. 4. For example, incentive criteria 435 may define one or more conditions for receiving an award and/or one or more processes for calculating a corresponding award. As previously explained, an example condition may be a minimum account balance, such as $100. An example process or calculation may be 5% of the account balance. In this case, the incentive amount may be $5. Other incentive criteria programming based on different conditions and/or calculation process may be identified as described with reference to FIG. 4. For example, a condition may be a maximum account balance for the beneficiary account.

In some embodiments, incentive processor 405 may provide a graphical user interface and/or a dashboard allowing sponsor 410 to define the incentive criteria programming. For example, a system corresponding to sponsor 410 may communicate with incentive processor 405 to view the graphical user interface and/or capture user interactions. This communication may be a web application. In some embodiments, the system corresponding to sponsor 410 may access and/or provide commands to incentive processor 405 via an API communication to define the incentive criteria programming. Incentive processor 405 may store the incentive criteria programming in memory or in a database. In some embodiments, the incentive criteria programming may indicate a periodic disbursement and/or a disbursement that occurs in multiple instances. Incentive processor 405 may maintain a schedule corresponding to the incentive criteria programming to identify the incentive criteria programming and to perform the distribution.

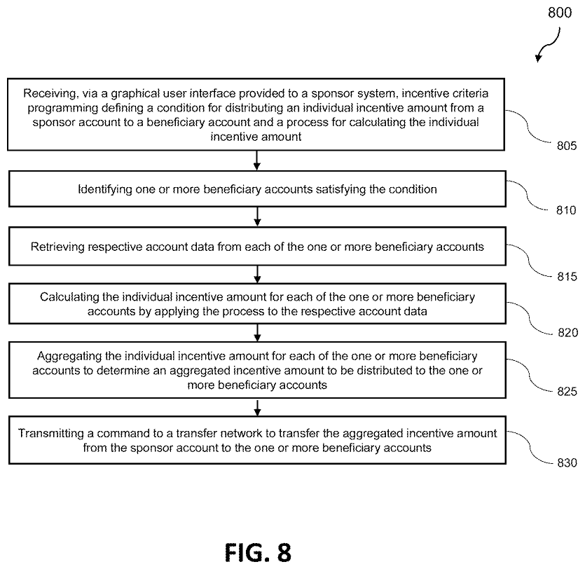

At 710, incentive processor 405 may retrieve data from the second account corresponding to the condition. As previously explained with reference to FIG. 4 and further explained with reference to FIG. 8, this data may be used to determine whether the second account satisfies the condition defined for the incentive criteria programming. For example, the data may include an account balance corresponding to the second account. In some embodiments, a condition may include identifying data corresponding to beneficiary 430. For example, this data may include a number of years that a beneficiary 430 has worked for a sponsor 410. The years of tenure may determine a particular rate for calculating an incentive amount. For example, a beneficiary 430 that has worked for less than a year may receive a 5% match while a beneficiary 430 who has worked for more than a year may receive a 5.5% match.

At 715, incentive processor 405 may determine that the data satisfies the condition while concealing the data from the sponsor 410. As previously explained with reference to FIG. 4 and further explained with reference to FIG. 8, personal information corresponding to beneficiary 430 may be concealed from sponsor 410. This may include, for example, an account balance corresponding to the second account or an average daily balance. In some embodiments, the condition may be that a beneficiary 430 receives the incentive amount when the employee has maintained a minimum account balance. For example, this minimum account balance may be $100 but the account balance of the second account may be $500. In this case, incentive processor 405 may determine that the condition is satisfied without revealing the actual $500 account balance to sponsor 410.

At 720, incentive processor 405 may calculate the incentive amount using the data and the incentive criteria programming. This calculation may occur using the processes previously described. For example, a percentage may be applied to the account balance. In the scenario where the incentive criteria programming provides a 5% match and the account balance is $500, the calculated incentive amount may be $25. As previously explained, the condition and/or calculation may follow customizable rules with one or more tiers of calculation. For example, a first tier may be a match of 5% up to the first $200 of an account balance while a second tier may be a match of 3% for the next $200 of an account balance. In some embodiments, the calculation may be based on a contribution to the second account. For example, the incentive may be a 5% match, except the first 3% is dollar for dollar and then the next one comes as $0.50 on the dollar, up to 5%. Incentive processor 405 may perform this calculation to determine the incentive amount for the second account corresponding to beneficiary 430.

At 725, incentive processor 405 may transmit a command to a transfer network 460 to transfer the incentive amount from the first account to the second account. For example, as described with reference to FIG. 4, incentive processor 405 may use an API mapping 450 to transmit a command to a financial institution system to distribute the incentive amount. In some embodiments, incentive processor 405 may send a push command to a money transfer network 460 to retrieve the incentive amount from an account corresponding to sponsor 410 and push that amount to an account corresponding to beneficiary 430. In some embodiments, this may be a modification of one or more ledgers. In some embodiments, incentive processor 405 may manage a nested ledger such that the second account is maintained as part of the first account. For example, an employer may have an arrangement where employee accounts are nested within the employer account. In this case, incentive processor 405 may still conceal employee account information from the employer account as well. This may occur even during the disbursement of incentive amounts.

FIG. 8 depicts a flowchart illustrating a method 800 for distributing an aggregated incentive amount to one or more beneficiary accounts, according to some embodiments. Method 800 shall be described with reference to FIG. 4; however, method 800 is not limited to that example embodiment.

In an embodiment, incentive processor 405 may utilize method 800 to distribute an aggregated incentive amount from a sponsor account to one or more beneficiary accounts. The sponsor account may correspond to sponsor 410. The one or more beneficiary accounts may correspond to beneficiaries 430. The foregoing description will describe an embodiment of the execution of method 800 with respect to incentive processor 405. While method 800 is described with reference to incentive processor 405, method 800 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 8, as will be understood by a person of ordinary skill in the art.

At 805, incentive processor 405 may receive, via a graphical user interface provided to a sponsor system, incentive criteria programming defining a condition for distributing an individual incentive amount from a sponsor account to a beneficiary account and a process for calculating the individual incentive amount. This may be similar to the process described with reference to FIG. 7. The graphical user interface may be a dashboard provided to a system corresponding to sponsor 410. For example, this interface may be provided via a web application and/or a cloud based computing platform. Using this interface, a user may define the incentive criteria programming. For example, a user may specify a condition for distributing an individual incentive amount from a sponsor account to a beneficiary account. This condition may be a condition as described with reference to FIG. 4 and FIG. 7.

The process for calculating the individual incentive amount may also be similar to the processes described with reference to FIG. 4 and FIG. 7. For example, the process may include an equation and/or a definition of one or more steps and/or conditions to determine an incentive amount. The process may include conditional elements such as personal attributes or characteristics corresponding to a beneficiary 430. For example, the conditional elements may include a number of years that the beneficiary 430 has worked for the sponsor 410, a company role or title corresponding to the beneficiary 430, and/or other characteristics. In some embodiments, the process for calculating the individual incentive amount may modify the condition for distributing an individual incentive amount. For example, if a beneficiary 430 is an hourly employee, the condition for receiving an incentive amount may be to maintain at least $100 in the beneficiary account. If the beneficiary 430 is a salaried employee, the condition for receiving an incentive amount may be to maintain at least $1000 in the beneficiary account. In some embodiments, this may be an average daily balance.

In some embodiments, a sponsor 410 may define a periodic distribution of the incentive amount. For example, the incentive criteria 435 may be set to distribute the incentive amount monthly, quarterly, yearly, or at another time interval. A sponsor 410 accessing incentive processor 405 may define, customize, and/or modify, the incentive criteria programming using the graphical user interface.

At 810, incentive processor 405 may identify one or more beneficiary accounts satisfying the condition. Incentive processor 405 may identify the qualifying beneficiary accounts without revealing the identity of the accounts and/or their corresponding beneficiaries 430 to sponsor 410. This identification may occur by checking account data for each beneficiary account based on the condition defined by sponsor 410. In some embodiments, this identification may occur by checking ledgers and/or databases maintained by incentive processor 405. The ledgers and/or databases may maintain beneficiary account information, such as account balances, personal data, and/or beneficiary characteristic data. This information may be used to identify the one or more beneficiary accounts. In some embodiments, the identification may occur via API calls to a financial institution server or system or a transfer network 460. In an example embodiment, the incentive criteria 435 may condition an incentive amount distribution on whether a beneficiary account includes at least $100. At 810, incentive processor 405 may identify the one or more beneficiary accounts satisfying this condition.

As will be further explained below, the condition for distributing an individual incentive amount may depend on a characteristic of the beneficiary 430. Incentive processor 405 may maintain ledgers and/or databased that include this characteristic data. These ledges and/or databases may have been pre-populated based on a previous pull of beneficiary 430 data from a system utilized by sponsor 410. For example, the beneficiary characteristic and/or personal data may be pulled from an HR system and/or a database of records maintained by sponsor 410. When identifying whether one or more beneficiary accounts satisfy the condition, incentive processor 405 may consult the information stored in the ledgers and/or databases.

In some embodiments, multiple categories of beneficiaries 430 may be defined with different conditions for receiving an incentive amount. For example, categories may be employees with less than one year of tenure, employees with one to five years of tenure, and employees with more than five years of tenure. Each category may include different conditions and/or processes for calculating the individual incentive amount. At 810, incentive processor 405 may identify one or more beneficiary accounts satisfying respective categorical conditions as well.

At 815, incentive processor 405 may retrieve respective account data from each of the one or more beneficiary accounts. Depending on the particular incentive criteria 435, 815 may occur before, after, and/or during 810. The retrieved account data may be the account data used to calculate the individual incentive amount for the particular beneficiary account. For example, the account data may include ledger data and/or behavioral data. As previously explained, an example of this account data may be an account balance and the process for calculation may be a percentage of the account balance. As previously explained, the one or more beneficiary accounts may have satisfied different conditions with different processes for calculating individual incentive amounts. At 815, incentive processor 405 may retrieve corresponding account data relevant to the conditions and/or incentive criteria 435 for the particular beneficiary accounts satisfying their respective conditions. For example, one condition may be based on account balance while another condition may be based on monthly contributions. Incentive processor 405 may account for these different conditions and/or identify the relevant account data (e.g., account balance or average monthly contribution) to apply to the calculation of the individual incentive amount. In some embodiments, the respective account data may be a respective account balance, a respective sub-account balance, or a respective account balance measured over time for each of the one or more beneficiary accounts.

At 820, incentive processor 405 may calculate the individual incentive amount for each of the one or more beneficiary accounts by applying the process to the respective account data. This may occur in the manner previously described. Incentive processor 405 may perform this calculation occurring the process defined by sponsor 410. This calculation may also differ for the different beneficiary accounts if sponsor 410 has defined different categories of beneficiaries 430 with different conditions and/or processes. In this manner, the calculated individual incentive amount may differ for each of the one or more beneficiary accounts based on their respective account data.

At 825, incentive processor 405 may aggregate the individual incentive amounts for each of the one or more beneficiary accounts to determine an aggregated incentive amount to be distributed to the one or more beneficiary accounts. In some embodiments, the aggregated incentive amount may be a sum of the individual incentive amounts for each of the one or more beneficiary accounts. This aggregated incentive amount may conceal the private information for the beneficiaries 430. The aggregated incentive amount may also conceal the individual incentive amounts calculated for each of the one or more beneficiary accounts from view by the sponsor system. In particular, sponsor 410 may be notified of and/or may identify the aggregated incentive amount but may not be able to access the individual incentive amounts. In this manner, confidential and/or private account data may be concealed from sponsor 410. For example, sponsor 410 may not be able to specifically see an individual account balance for a particular beneficiary 430. This may be masked and/or concealed by the aggregated incentive amount. This concealment may also be furthered if sponsor 410 has defined multiple categories and/or incentive criteria 435. While incentive processor 405 may apply the different conditions and/or processes for calculating the individual incentive amounts, the incentive processor 405 may not return these individual calculations to sponsor 410. Rather, incentive processor 405 may return the aggregated incentive amount to sponsor 410 to conceal the underlying account data and/or the identity of beneficiary account satisfying the condition. In some embodiments, incentive processor 405 may transmit a notification to the graphical user interface provided to the sponsor system indicating the aggregated incentive amount.

At 830, incentive processor 405 may transmit a command to a transfer network 460 to transfer the aggregated incentive amount from the sponsor account to the one or more beneficiary accounts. This may occur in a manner similar to 725 as described with reference to FIG. 7. In some embodiments, incentive processor 405 may transmit one or more commands to execute the corresponding transfers. For example, while incentive processor 405 may conceal the individual incentive amounts calculated, incentive processor 405 may individually process and/or route the corresponding individual incentive amounts to the respective beneficiary accounts. In some embodiments, incentive processor 405 may transmit a command identifying the one or more beneficiary accounts with their corresponding individual incentive amounts to be routed by the financial institution system and/or transfer network 460.

In some embodiments, the processes described with reference to FIGS. 4, 7, and 8 may be executed using batch-driven processing. Incentive processor 405 may apply batch processing to process tasks in an automated fashion and/or using a group processing framework to provide efficient calculations and/or computer processing. For example, incentive processor 405 may manage and/or execute batch functions according to a time schedule. Incentive processor 405 may apply batch processing across active incentivizations and/or conditions specified by sponsors 410. The batch processing may be performed across one or more sponsors 410 and/or beneficiaries 430. The batch processing may also apply to multiple conditions and/or incentive amount calculations to more efficiently determine individual incentive amounts and/or aggregated incentive amounts. This may apply to processing performed for multiple beneficiaries 430 corresponding to a particular sponsor 410 and/or multiple beneficiaries 430 corresponding to multiple sponsors 410. In this case, incentive processor 405 may provide associated auto-scaling using batch processing to efficiently allocate computing resources to perform the calculations. This may also positively reinforce a social network effect for beneficiaries 430.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
receiving, via a graphical user interface provided to a sponsor system, incentive criteria programming defining a condition for distributing an individual incentive amount from a sponsor account to a beneficiary account and a process for calculating the individual incentive amount;
identifying one or more beneficiary accounts satisfying the condition;
retrieving respective account data from each of the one or more beneficiary accounts;
calculating the individual incentive amount for each of the one or more beneficiary accounts by applying the process to the respective account data;
aggregating the individual incentive amount for each of the one or more beneficiary accounts to determine an aggregated incentive amount to be distributed to the one or more beneficiary accounts and to conceal the individual incentive amount for each of the one or more beneficiary accounts from the sponsor system; and
transmitting a command to a transfer network to transfer the aggregated incentive amount from the sponsor account to the one or more beneficiary accounts.

2. The computer implemented method of claim 1, wherein the condition is a minimum or maximum account balance for the beneficiary account and the process is applying a percentage to an account balance corresponding to the beneficiary account.

3. The computer implemented method of claim 1, wherein the respective account data is a respective account balance, a respective sub-account balance, or a respective account balance measured over time for each of the one or more beneficiary accounts.

4. The computer implemented method of claim 1, further comprising:
generating a dashboard graphical user interface configured to display the condition for distributing an individual incentive amount, the process for calculating the individual incentive amount, and an account balance corresponding to the beneficiary account.

5. The computer implemented method of claim 1, wherein the condition includes a first condition corresponding to a first category of beneficiaries and a second condition corresponding to second category of beneficiaries.

6. The computer implemented method of claim 1, wherein the condition specifies a periodic disbursement for the individual incentive amount.

7. The computer implemented method of claim 1, further comprising:
transmitting a notification of the aggregated incentive amount to the graphical user interface provided to the sponsor system.

8. A system, comprising:
a memory; and
at least one processor coupled to the memory and configured to apply batch processing to determine an aggregated incentive amount, wherein the at least one processor is further configured to:
receive, via a graphical user interface provided to a sponsor system, incentive criteria programming defining a condition for distributing an individual incentive amount from a sponsor account to a beneficiary account and a process for calculating the individual incentive amount;
identify one or more beneficiary accounts satisfying the condition;
retrieve respective account data from each of the one or more beneficiary accounts;
calculate the individual incentive amount for each of the one or more beneficiary accounts by applying the process to the respective account data;
aggregate the individual incentive amount for each of the one or more beneficiary accounts to determine the aggregated incentive amount to be distributed to the one or more beneficiary accounts and to conceal the individual incentive amount for each of the one or more beneficiary accounts from the sponsor system; and
transmit a command to a transfer network to transfer the aggregated incentive amount from the sponsor account to the one or more beneficiary accounts.

9. The system of claim 8, wherein the condition is a minimum or maximum account balance for the beneficiary account and the process is applying a percentage to an account balance corresponding to the beneficiary account.

10. The system of claim 8, wherein the respective account data is a respective account balance, a respective sub-account balance, or a respective account balance measured over time for each of the one or more beneficiary accounts.

11. The system of claim 8, wherein the at least one processor is further configured to:
generate a dashboard graphical user interface configured to display the condition for distributing an individual incentive amount, the process for calculating the individual incentive amount, and an account balance corresponding to the beneficiary account.

12. The system of claim 8, wherein the condition includes a first condition corresponding to a first category of beneficiaries and a second condition corresponding to second category of beneficiaries.

13. The system of claim 8, wherein the condition specifies a periodic disbursement for the individual incentive amount.

14. The system of claim 8, wherein the at least one processor is further configured to:
transmit a notification of the aggregated incentive amount to the graphical user interface provided to the sponsor system.

15. A non-transitory computer-readable device having instructions stored thereon that, when executed by at least one computing device, cause the at least one computing device to perform operations comprising:
receiving, via a graphical user interface provided to a sponsor system, incentive criteria programming defining a condition for distributing an individual incentive amount from a sponsor account to a beneficiary account and a process for calculating the individual incentive amount;
identifying one or more beneficiary accounts satisfying the condition;
retrieving respective account data from each of the one or more beneficiary accounts;
calculating the individual incentive amount for each of the one or more beneficiary accounts by applying the process to the respective account data;
aggregating the individual incentive amount for each of the one or more beneficiary accounts to determine an aggregated incentive amount to be distributed to the one or more beneficiary accounts and to conceal the individual incentive amount for each of the one or more beneficiary accounts from the sponsor system; and
transmitting a command to a transfer network to transfer the aggregated incentive amount from the sponsor account to the one or more beneficiary accounts.

16. The non-transitory computer-readable device of claim 15, wherein the condition is a minimum or maximum account balance for the beneficiary account and the process is applying a percentage to an account balance corresponding to the beneficiary account.

17. The non-transitory computer-readable device of claim 15, wherein the respective account data is a respective account balance, a respective sub-account balance, or a respective account balance measured over time for each of the one or more beneficiary accounts.

18. The non-transitory computer-readable device of claim 15, the operations further comprising:
generating a dashboard graphical user interface configured to display the condition for distributing an individual incentive amount, the process for calculating the individual incentive amount, and an account balance corresponding to the beneficiary account.

19. The non-transitory computer-readable device of claim 18, wherein the condition includes a first condition corresponding to a first category of beneficiaries and a second condition corresponding to second category of beneficiaries.

20. The non-transitory computer-readable device of claim 15, the operations further comprising:
transmit a notification of the aggregated incentive amount to the graphical user interface provided to the sponsor system.
